(19) United States
(12) Patent Application Publication
(10) Pub. No.: US 2018/0029452 A1
(43) Pub. Date: Feb. 1, 2018

(54) VEHICLE OPENING AND CLOSING BODY OPERATING DEVICE

(71) Applicant: AISIN SEIKI KABUSHIKI KAISHA, Kariya-shi (JP)

(72) Inventors: Satoshi SHIBAYAMA, Nagoya-shi (JP); Sadayuki MAKINO, Nagoya-shi (JP)

(73) Assignee: AISIN SEIKI KABUSHIKI KAISHA, Kariya-shi (JP)

(21) Appl. No.: 15/621,417

(22) Filed: Jun. 13, 2017

(30) Foreign Application Priority Data
Jul. 28, 2016 (JP) 2016-148496

(51) Int. Cl. B60J 5/04; B60J 5/00; E05B 17/00; E05B 81/20

(52) U.S. Cl. CPC B60J 5/04; E05B 81/20; B60J 5/00; E05B 17/00; E05B 81/16

(57) ABSTRACT

A vehicle opening and closing body operating device includes: a support member having a vertical wall portion, holding grooves into which cables are inserted and which are formed in the vertical wall portion to be opened in a standing direction of the vertical wall portion and to be in parallel in one direction, each of the holding grooves communicating in a plate thickness direction of the vertical wall portion, and a support side locking portion which is provided between the adjacent holding grooves; and a cover having a shaft portion supported on the vertical wall portion to be pivotable about an axis extending in the plate thickness direction, an arm portion extending from the shaft portion along the vertical wall portion to cover openings of the holding grooves, and a cover side locking portion provided on the arm portion and hooked with the support side locking portion.

### CROSS REFERENCE TO RELATED APPLICATIONS

This application is based on and claims priority under 35 U.S.C. § 119 to Japanese Patent Application 2016-148496, filed on Jul. 28, 2016, the entire contents of which are incorporated herein by reference.

### TECHNICAL FIELD

This disclosure relates to a vehicle opening and closing body operating device.

### BACKGROUND DISCUSSION

In the related art, for example, a vehicle opening and closing body operating device disclosed in JP 2012-072645 A (Reference 1) has been known. The vehicle opening and closing body operating device (remote control device) is installed in a vehicle opening and closing body (slide door), and has a support member (mechanism board), and a plurality of levers or the like (hereinafter, referred to as “mechanism parts”) supported on the support member. The mechanism parts are connected to a plurality of (three) door lock devices installed on the vehicle opening and closing body through cables, respectively, and output release operating force to the door lock devices. Therefore, the door lock device turns the vehicle opening and closing body, which has been held in the closed state, into an openable state.

Here, an example of a holding structure for the plurality of cables of the vehicle opening and closing body operating device will be described.

As illustrated in FIG. 4, a support member 90 of a vehicle opening and closing body operating device has a vertical wall portion 91 which has a plurality of holding grooves 92 formed in parallel in one direction (left-and-right direction in the drawing). Each of the holding grooves 92 has a substantially U shape that is opened in the standing direction of the vertical wall portion 91 (upward in the drawing). Further, a substantially triangular-shaped support side locking portion 93 protrudes on a tip end at one side (left side in the drawing) of the vertical wall portion 91 in a direction in which the plurality of holding grooves 92 is provided in parallel.

Cables 94 (strictly speaking, a terminal end portion of an outer cable which retractably accommodates a driving inner cable) are inserted into the holding grooves 92, respectively, in a communication direction of the holding grooves 92 (direction orthogonal to the page surface). Further, a cover 95, which prevents the plurality of cables 94 from coming off, is mounted on the vertical wall portion 91.

That is, the cover 95 has a shaft portion 96, which is supported on the vertical wall portion 91 to be pivotable about an axis O that extends in a plate thickness direction (direction orthogonal to the page surface), at the opposite side to the support side locking portion 93 with respect to the plurality of cables 94, the cover 95 has an arm portion 97 which extends from the shaft portion 96 along the vertical wall portion 91, and the cover 95 also has a substantially claw-shaped cover side locking portion 98 which is vertically provided on the arm portion 97. As indicated by an alternate long and two short dashes line in the drawing, the cover side locking portion 98 is hooked by the support side locking portion 93 at a rotation position about the axis O where a tip end portion of the arm portion 97 becomes close to openings of the plurality of holding grooves 92 such that the cover 95 is fixed to the vertical wall portion 91. Therefore, the openings of the plurality of holding grooves 92 into which the cables 94 are inserted are covered together by the arm portion 97, so that the plurality of cables 94 inserted into the holding grooves 92 is prevented from coming off.

By the way, the cover 95 has a structure in which the cables 94, which are about to come off from the respective holding grooves 92, are supported by the cover side locking portion 98 hooked by the support side locking portion 93. For this reason, the moment of force, which is generated by the cable 94 that is about to come off from the holding groove 92 at a side (right side in the drawing) relatively spaced apart from the cover side locking portion 98, is increased, and as a result, it is necessary to ensure the strength of the cover side locking portion 98 and the like to that extent.

Thus, a need exists for a vehicle opening and closing body operating device which is not susceptible to the drawback mentioned above.

### SUMMARY

A vehicle opening and closing body operating device according to an aspect of this disclosure includes: a support member having a vertical wall portion, a plurality of holding grooves into which cables are inserted and which are formed in the vertical wall portion to be opened in a standing direction of the vertical wall portion and to be in parallel in one direction, each of the holding grooves communicating in a plate thickness direction of the vertical wall portion, and a support side locking portion which is provided between the adjacent holding grooves; and a cover having a shaft portion supported on the vertical wall portion to be pivotable about an axis extending in the plate thickness direction, an arm portion extending from the shaft portion along the vertical wall portion to cover openings of the plurality of holding grooves, and a cover side locking portion provided on the arm portion and hooked with the support side locking portion.

### BRIEF DESCRIPTION OF THE DRAWINGS

The foregoing and additional features and characteristics of this disclosure will become more apparent from the following detailed description considered with the reference to the accompanying drawings, wherein:

FIGS. 1A and 1B are perspective views illustrating a structure of an exemplary embodiment of a vehicle opening and closing body operating device after the assembly of the device and before the assembly of the device, respectively;

FIGS. 2A and 2B are side views illustrating the structure of the vehicle opening and closing body operating device of the same exemplary embodiment after the assembly of the device and before the assembly of the device, respectively;

FIG. 3 is a side view illustrating a schematic configuration of a slide door; and

FIG. 4 is a side view illustrating a structure of a vehicle opening and closing body operating device in the related art.

### DETAILED DESCRIPTION

Hereinafter, an exemplary embodiment of a vehicle opening and closing body operating device will be described. Further, hereinafter, a front-and-rear direction of a vehicle will be referred to as a “front-and-rear direction,” and an upper side and a lower side in a height direction of the vehicle will be referred to as an “upper side” and a “lower side,” respectively. In addition, an interior side in a width direction of the vehicle, which is directed toward the interior of a vehicle interior, will be referred to as a “vehicle interior side,” and an exterior side in the width direction of the vehicle, which is directed toward the exterior of the vehicle interior, will be referred to as a “vehicle exterior side.”

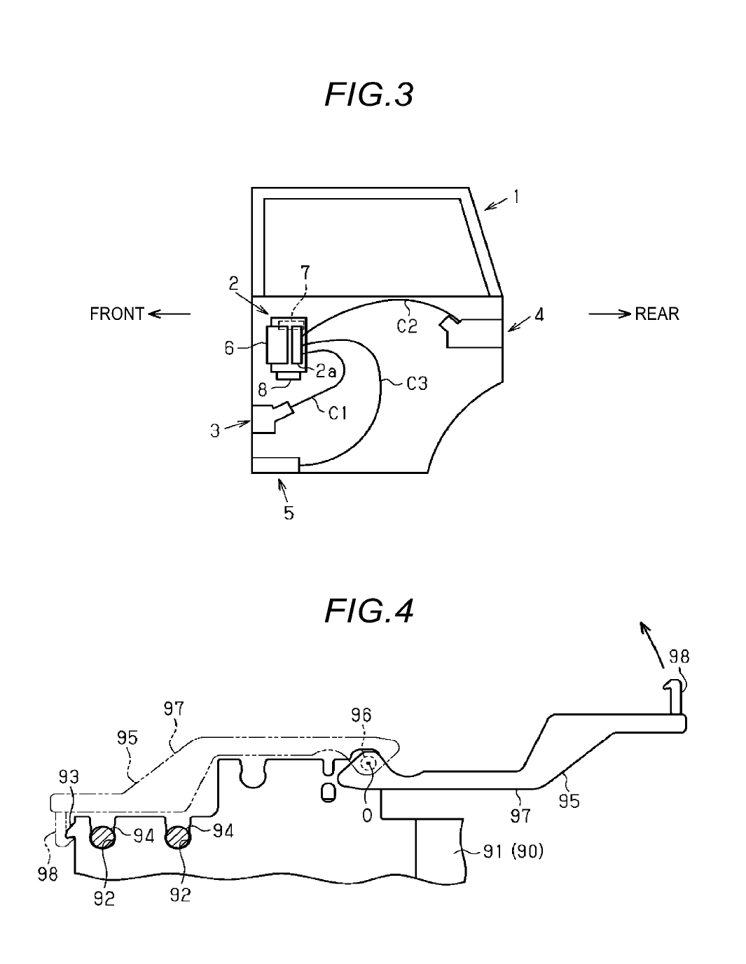

As illustrated in FIG. 3, a slide door 1, which is a vehicle opening and closing body supported on a lateral portion of a vehicle body via an appropriate support member (not illustrated), is configured to open and close an opening of a boarding door following a movement in the front-and-rear direction.

A remote control device 2 is installed in the slide door 1. The remote control device 2 has a mechanism part 2a including a plurality of levers and the like. In addition, a front lock 3 and a rear lock 4 are installed at front and rear sides in the slide door 1, respectively, and a full-open lock 5 is installed at a lower side in the slide door 1. The front lock 3, the rear lock 4, and the full-open lock 5 constitute a latch unit known in the related art.

Each of the front lock 3 and the rear lock 4 is engaged at the vehicle body side and maintains the slide door 1 in a closed state (fully closed state or half opened state). Further, the front lock 3 and the rear lock 4 are connected to the mechanism part 2a of the remote control device 2 through cables C1 and C2, respectively, and receive release operating force from the mechanism part 2a so as to turn the slide door 1 into an openable state with respect to the vehicle body. The full-open lock 5 is engaged at the vehicle body side and maintains the slide door 1 in a fully opened state. The full-open lock 5 is connected to the mechanism part 2a of the remote control device 2 through a cable C3, and receives release operating force from the mechanism part 2a so as to turn the slide door 1 into a closable state with respect to the vehicle body.

The remote control device 2 includes an inside handle 6 that is installed at the vehicle interior side thereof. The inside handle 6 is mechanically linked to the mechanism part 2a of the remote control device 2, and inputs release operating force to each of the front lock 3, the rear lock 4, and the full-open lock 5 through the mechanism part 2a.

For example, in the closed state of the slide door 1, the inside handle 6, which is operated rearward from a neutral position by an occupant, inputs release operating force to the mechanism part 2a, thereby inputting the release operating force to each of the front lock 3 and the rear lock 4 through the mechanism part 2a. Meanwhile, in the fully opened state of the slide door 1, the inside handle 6, which is operated forward from the neutral position by the occupant, inputs release operating force to the mechanism part 2a, thereby inputting the release operating force to the full-open lock 5 through the mechanism part 2a.

The slide door 1 has an outside handle 7 that is installed at the vehicle exterior side thereof. The outside handle 7 is also mechanically linked to the mechanism part 2a of the remote control device 2, and inputs release operating force to the front lock 3, the rear lock 4, and the full-open lock 5 through the mechanism part 2a.

For example, in the closed state of the slide door 1, the outside handle 7, which is operated rearward from the neutral position by the occupant, inputs release operating force to the mechanism part 2a, thereby inputting the release operating force to the front lock 3 and the rear lock 4 through the mechanism part 2a. Meanwhile, in the fully opened state of the slide door 1, the outside handle 7, which is operated forward from the neutral position by the occupant, inputs release operating force to the mechanism part 2a, thereby inputting the release operating force to the full-open lock 5 through the mechanism part 2a.

A release motor 8, which is configured with an electric motor, is installed within the slide door 1. The release motor 8 is also mechanically linked to the mechanism part 2a of the remote control device 2, and inputs release operating force to each of the front lock 3, the rear lock 4, and the full-open lock 5 through the mechanism part 2a.

For example, in the closed state of the slide door 1, the release motor 8, which is remotely operated by the occupant (operated an electronic key or a door opening and closing button in the vehicle), inputs release operating force to the mechanism part 2a, thereby inputting the release operating force to each of the front lock 3 and the rear lock 4 through the mechanism part 2a. Alternatively, the release motor 8 may continuously input the release operating force to the mechanism part 2a when a predetermined condition is satisfied (e.g., in a case in which a so-called power slide door device for electrically opening and closing the slide door 1 is mounted, until the rear lock 4 is unlocked and the power slide door device begins the opening and closing operation). Meanwhile, in the fully opened state of the slide door 1, the release motor 8, which is remotely operated by the occupant, inputs release operating force to the mechanism part 2a, thereby inputting the release operating force to the full-open lock 5 through the mechanism part 2a. Alternatively, the release motor 8 may continuously input the release operating force to the mechanism part 2a when a predetermined condition is satisfied.

Next, a holding structure for the plurality of cables C1 to C3 according to the remote control device 2 will be described.

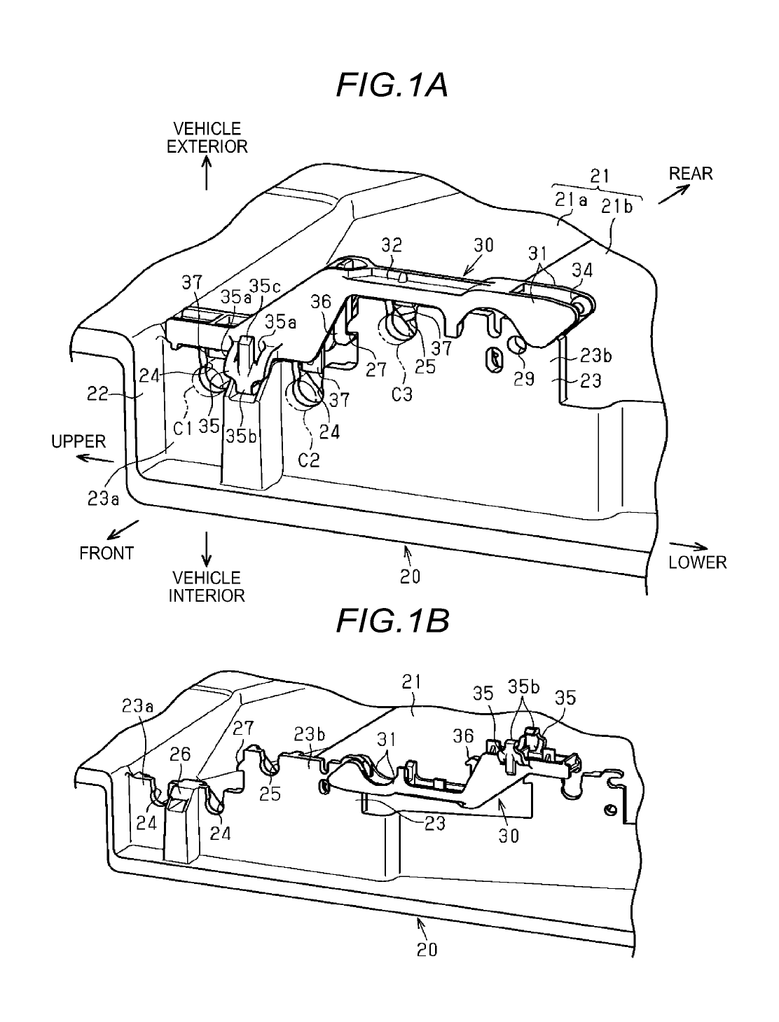

As illustrated in FIGS. 1A and 1B, the remote control device 2 is provided with a base board 20 as a support member that constitutes a housing. The base board 20 supports the mechanism part 2a or the inside handle 6. In addition, the base board 20 may support the release motor 8.

The base board 20 has a base portion 21 that is widened along an installation surface with the slide door 1. The base portion 21 is divided into a first base portion 21a and a second base portion 21b in the height direction of the vehicle (left-and-right direction in the drawing), and the first base portion 21a is more recessed than the second base portion 21b at the vehicle interior side. In addition, the base board 20 has a sidewall 22 which approximately orthogonally stands along an upper edge of the first base portion 21a from the first base portion 21a toward the vehicle exterior side. Further, the base board 20 has a vertical wall portion 23 which approximately orthogonally stands from the base portion 21 toward the vehicle exterior side and extends in the height direction of the vehicle. The vertical wall portion 23 includes a first vertical wall portion 23a and a second vertical wall portion 23b which stand from the first base portion 21a and the second base portion 21b, respectively, and the first vertical wall portion 23a is more depressed toward the vehicle interior side by the recessed portion of the first base portion 21a than the second vertical wall portion 23b. Further, an upper edge of the first vertical wall portion 23a is connected to the sidewall 22 to be approximately orthogonal to the sidewall 22, and a lower edge of the first vertical wall portion 23a is integrated with the second vertical wall portion 23b in a state in which the lower edge of the first vertical wall portion 23a is connected to a stepped portion between the first and second base portions 21a and 21b to be approximately orthogonal to the stepped portion.

A plurality of (two) first holding grooves 24, as substantially U-shaped holding grooves opened toward the vehicle exterior side (standing direction), is formed at an end portion of the first vertical wall portion 23a at the vehicle exterior side so as to be in parallel in the height direction (one direction) of the vehicle. Therefore, the two first holding grooves 24 communicate with each other in a plate thickness direction of the first vertical wall portion 23a which approximately coincides with the front-and-rear direction. Further, a tip end portion of the cable C1, which extends from the rear side of the vehicle, is inserted into the first holding groove 24 at an upper side, and a tip end portion of the cable C2, which similarly extends from the rear side of the vehicle, is inserted into the first holding groove 24 at a lower side.

A substantially U-shaped second holding groove 25 opened toward the vehicle exterior side is formed at an upper end portion of the second vertical wall portion 23b at the vehicle exterior side. Therefore, the second holding groove 25 communicates in the plate thickness direction of the second vertical wall portion 23b which approximately coincides with the front-and-rear direction. Further, a tip end portion of the cable C3, which extends from the rear side of the vehicle, is inserted into the second holding groove 25.

Each of the cables C1 to C3 has a driving inner cable and an external cable which retractably accommodates the inner cable, and the inner cable is connected to the mechanism part 2a in a state in which an end portion of the external cable is inserted into and held in the first holding groove 24 or the second holding groove 25.

Substantially triangular support side locking claws 26, as support side locking portions, are provided on the first vertical wall portion 23a so as to protrude on the opposite sides in the front-and-rear direction (plate thickness direction) between the adjacent first holding grooves 24, so that the support side locking claws 26 protrude at the opposite sides in the plate thickness direction of the first vertical wall portion 23a. Each of the support side locking claws 26 is inclined toward the vehicle interior side in the front-and-rear direction from a vehicle exterior side end of the first vertical wall portion 23a, and bent in the front-and-rear direction to be approximately orthogonal to the first vertical wall portion 23a from the tip end of the inclination. Meanwhile, a substantially triangular support side auxiliary claw 27 is provided on the second vertical wall portion 23b to protrude upward from an upper end of the second vertical wall portion 23b at the opposite sides in the plate thickness direction.

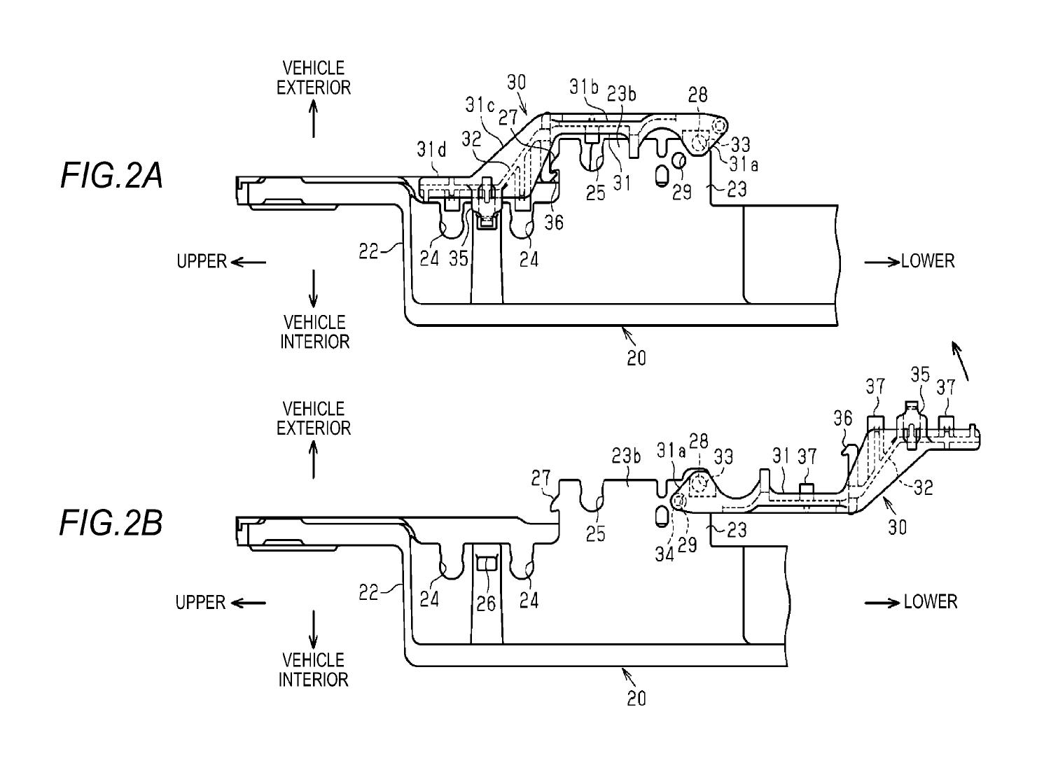

As illustrated in FIGS. 2A and 28, a substantially circular bearing hole 28 is formed at the lower end portion of the second vertical wall portion 23b at the vehicle exterior side, and a substantially circular temporary tacking hole 29 is formed to be adjacent to an upward oblique vehicle interior side of the bearing hole 28. Further, a cover 30, which is made of, for example, a resin, is connected to the second vertical wall portion 23b. That is, the cover 30 has a pair of sidewall portions 31 which is installed in parallel in the front-and-rear direction (direction orthogonal to the paper surface) so that the vertical wall portion 23 is interposed between the sidewall portions 31, and the cover 30 has a connecting wall portion 32 which is connected to the two sidewall portions 31 in the front-and-rear direction.

Each of the sidewall portions 31 has a substantially triangular support portion 31a which surrounds the bearing hole 28, and each of the sidewall portions 31 has a base end side extension portion 31b which extends upward from the support portion 31a along a vehicle exterior side end of the second vertical wall portion 23b. In addition, each of the sidewall portions 31 has an intermediate extension portion 31c which is connected to the tip end of the base end side extension portion 31b and extends toward the upward oblique vehicle interior side so as to absorb a level difference between the first and second vertical wall portions 23a and 23b, and each of the sidewall portions 31 has a tip end side extension portion 31d which is connected to a tip end of the intermediate extension portion 31c and extends upward along a vehicle exterior side end of the first vertical wall portion 23a. Further, the connecting wall portion 32 is adjacent to the vehicle interior sides of the first and second vertical wall portions 23a and 23b (vertical wall portion 23), extends along the vehicle interior sides of the first and second vertical wall portions 23a and 23b, and covers the openings of the two first holding grooves 24 and the opening of the second holding groove 25. The two sidewall portions 31 and the connecting wall portion 32 constitute an arm portion.

A substantially cylindrical shaft portion 33, which is approximately concentric with the bearing hole 28 and faces the bearing hole 28, protrudes on each of the support portions 31a. The shaft portion 33 is inserted into the bearing hole 28 and supported to be pivotable about the bearing hole 28 (about an axis extending in the plate thickness direction). In addition, a substantially truncated conical temporary tacking protrusion 34, which is approximately concentric with the temporary tacking hole 29 and faces the temporary tacking hole 29 when the sidewall portion 31 is positioned to extend downward so as to be reversed from the vertical wall portion 23 side in accordance with the rotation about the shaft portion 33, protrudes on each of the support portions 31a. The temporary tacking protrusion 34 is inserted into the temporary tacking hole 29, thereby minimally maintaining the position of the sidewall portion 31.

As illustrated in FIGS. 1A and 1B, cover side locking portions 35 protrude on the two sidewall portions 31 in the front-and-rear direction (plate thickness direction of the vertical wall portion 23) opposite to each other. Each of the cover side locking portions 35 has a pair of extending portions 35a which extend toward the oblique vehicle interior side in the front-and-rear direction from the sidewall portion 31 at a position in the height direction of the vehicle where the support side locking claw 26 is interposed, and each of the cover side locking portions 35 has a substantially hook-shaped cover side locking claw 35b which is connected to the extending portions 35a in a state of being interposed between the extending portions 35a and extends toward the vehicle interior side. Each of the cover side locking portions 35 is hooked with the support side locking claw 26 by the cover side locking claw 35b, which faces the support side locking claw 26 in the front-and-rear direction. Further, the cover 30 has substantially quadrangular bar-shaped release protrusion pieces 35c which extend from the cover side locking claws 35b toward the vehicle exterior side (standing direction of the vertical wall portion 23).

Meanwhile, a substantially hook-shaped cover side auxiliary claw 36 protrudes on the connecting wall portion 32 to be adjacent to an upper side of the support side auxiliary claw 27. The cover side auxiliary claw 36 is hooked with the support side auxiliary claw 27. In addition, a plurality of (three) substantially quadrangular claw-shaped pressing pieces 37 protrudes on the connecting wall portion 32 to face the openings of the two first holding grooves 24 and the second holding groove 25. Each of the pressing pieces 37 serves to press and insert the cables C1 to C3, which are assembled from the opening sides of the two first holding grooves 24 and the second holding groove 25, into sides (depth sides) opposite to the openings in conjunction with the assembly of the cover 30.

Next, an aspect in which the cables C1 to C3 are assembled to the vertical wall portion 23 will be described.

As illustrated in FIG. 2B, when assembling the cables C1 to C3, the two temporary tacking protrusions 34 are inserted into the temporary tacking hole 29 at a rotation position of the cover 30 about the shaft portion 33 at which the two sidewall portions 31 and the connecting wall portion 32 (the arm portion) are in advance positioned to extend downward from the shaft portion 33 to be reversed from the vertical wall portion 23 side (in other words, at a position where the cover is rotated about the shaft portion and the openings of the first holding groove 24 and the second holding groove 25 are opened). Therefore, the cover 30 is minimally held at the rotation position. That is, in a state in which a swing of the cover 30 about the shaft portion 33 is restricted, the opened state of the openings of the two first holding grooves 24 and the opening of the second holding groove 25, which are assembly routes of the cables C1 to C3, is maintained.

In this state, the cables C1 to C3 are assembled from the opening sides of the two first holding grooves 24 and the second holding groove 25.

As illustrated by a change to FIG. 2A, according to the rotation of the cover 30 about the shaft portion 33, the two sidewall portions 31 and the connecting wall portion 32 (the arm portion) are turned to a rotation position at which the two sidewall portions 31 and the connecting wall portion 32 are positioned to extend upward from the shaft portion 33 along the vertical wall portion 23. In this case, the two temporary tacking protrusions 34 elastically deform the two support portions 31a in the mutually opposite directions in the front-and-rear direction so as to allow the two support portions 31a to be released from the temporary tacking hole 29, and the two cover side locking portions 35 are guided to the two support side locking claws 26 to move over the two support side locking claws 26 while being elastically deformed in the mutually opposite directions in the front-and-rear direction, so that the two support side locking claws 26 are hooked with the cover side locking portions 35. At the same time, the support side auxiliary claw 27 is hooked with the cover side auxiliary claw 36. Further, the openings of the two first holding grooves 24 and the opening of the second holding groove 25 are covered by the connecting wall portion 32. In addition, the plurality of pressing pieces 37 is moved to face the openings of the two first holding grooves 24 and the opening of the holding groove 25, and for example, the cables C1 to C3, which are not completely assembled, are pressed and inserted into the sides opposite to the openings (depth sides).

As described above, the cables C1 to C3 are completely assembled to the vertical wall portion 23 (remote control device 2).

Next, an effect of the exemplary embodiment will be described together with the action of the exemplary embodiment.

(1) In the exemplary embodiment, the cover 30 supports the cables C1 and C2, which are about to come off from the respective first holding grooves 24, by the cover side locking portions 35 that are hooked with the support side locking claws 26 positioned between the adjacent first holding grooves 24. In this case, a separation distance between the cover side locking portion 35 and each of the first holding grooves 24 may be set to be smaller than a separation distance between the adjacent first holding grooves 24. Therefore, it is possible to reduce moment of force generated by the cables C1 and C2 which are about to come off from the first holding grooves 24, and it is possible to further reduce the strength, which is required for the cover side locking portion 35 and the like, to that extent. In addition, the cover 30 may be further reduced in size. In addition, since each of the cover side locking portions 35 is provided on the sidewall portion 31 (arm portion) to protrude in the front-and-rear direction (plate thickness direction of the vertical wall portion 23), that is, each of the cover side locking portions 35 is shifted in relation to the vertical wall portion 23 in the front-and-rear direction, it is possible for the cover side locking portions 35 to avoid interference with the vertical wall portion 23 even though the cover side locking portions 35 are disposed between the adjacent first holding grooves 24.

(2) In the present exemplary embodiment, the two sets of support side locking claws 26 and cover side locking portions 35, which are disposed at opposite sides in the front-and-rear direction (plate thickness direction of the vertical wall portion 23), are hooked with each other, and as a result, the cover 30 may more firmly support the cables C1 and C2 which are about to come off from the respective first holding grooves 24.

(3) In the present exemplary embodiment, when the release protrusion pieces 35c are elastically deformed in the front-and-rear direction (plate thickness direction of the vertical wall portion 23) toward the vertical wall portion 23, the cover side locking portions 35 are elastically deformed by the reaction force in the front-and-rear direction away from the vertical wall portion 23, that is, in the direction in which a hooking area with the support side locking claws 26 is decreased. Therefore, it is possible to more simply release the cover side locking portions 35 from the support side locking claws 26, and further, it is possible to more smoothly perform an operation of removing the cover 30. In particular, the release protrusion pieces 35c, which are disposed at opposite sides in the front-and-rear direction, are interposed therebetween and moved upward while being elastically deformed in the front-and-rear direction in which the release protrusion pieces 35c move close to each other, and as a result, it is possible to simply remove the cover 30.

(4) In the present exemplary embodiment, the pressing pieces 37, which face the openings of the two first holding grooves 24 and the opening of the second holding groove 25, protrude on the connecting wall portion 32 (arm portion), and as a result, it is possible to more reliably assemble the cables C1 to C3 which are incompletely assembled to the grooves.

(5) In the present exemplary embodiment, the temporary tacking hole 29 and the temporary tacking protrusions 34 are provided on the vertical wall portion 23 and the support portion 31a (arm portion), respectively, and the rotated position of the cover 30 is minimally maintained by the engagement between the temporary tacking hole 29 and the temporary tacking protrusions 34, and as a result, it is possible to more improve the assemblability of the cables C1 to C3. In addition, since the temporary tacking protrusions 34 have a substantially truncated conical shape, the temporary tacking protrusions 34 may be smoothly released from the temporary tacking hole 29 while the temporary tacking hole 29 is guided by the (tapered) lateral surfaces of the temporary tacking protrusions 34.

(6) In the present exemplary embodiment, there is no engagement claw (corresponding to the cover side locking portion 98) at the tip end (upper end) of the cover 30. For this reason, for example, between the sidewall 22 and the vertical wall portion 23, it is not necessary to provide an engagement portion to be hooked with such an engagement claw, or secure a workspace in which the engagement claw is hooked, and as a result, it is possible to reduce the size of the entire device in a direction in which the vertical wall portion 23 extends (height direction of the vehicle), and it is possible to further reduce the mass of the device to that extent.

The exemplary embodiment may be changed as follows.
In the exemplary embodiment, the temporary tacking hole 29 and the two temporary tacking protrusions 34 may be omitted.
In the exemplary embodiment, at least one of the plurality of pressing pieces 37 may be omitted.
In the exemplary embodiment, the temporary tacking hole 29 is provided in the support member 90, and the two temporary tacking protrusions 34 are provided on the cover 30. However, the temporary tacking hole may be provided in the cover 30, and the temporary tacking protrusions may be provided on the support member 90.
In the exemplary embodiment, the release protrusion pieces 35c may be omitted.
In the exemplary embodiment, the support side locking claws 26 and the cover side locking portions 35 may be disposed only at one side in the front-and-rear direction (plate thickness direction of the vertical wall portion 23).
In the exemplary embodiment, the cables C1 and C2, which are about to come off, are supported by the cover side locking portion 35 which is hooked with the support side locking claws 26 positioned between the adjacent first holding grooves 24 in the height direction (one direction) of the vehicle. In contrast, in a case in which the second holding groove 25 is disposed adjacent to the other first holding groove 24 instead of any one of the two first holding grooves 24, the cable C3, which is about to come off, may also be supported by the cover side locking portions 35 which are hooked the support side locking claws 26 positioned between the first holding groove 24 and the second holding groove 25.

Alternatively, in a case in which the second holding groove 25 is disposed in parallel with the two first holding grooves 24 in the height direction (one direction) of the vehicle, the cable C3, which is about to come off, may also be supported by the cover side locking portions 35 which are hooked with the support side locking claws 26 positioned between the adjacent first holding grooves 24 and the second holding groove 25.
The vertical wall portion 23 adopted in the exemplary embodiment includes the first and second vertical wall portions 23a and 23b which are stepped to correspond to the unevenness of the base portion 21. However, for example, the tip end of the vertical wall portion in the standing direction may extend rectilinearly.
In the exemplary embodiment, any one of the inside handle 6, the outside handle 7, and the release motor 8 may be connected to the mechanism part 2a of the remote control device 2 through cables. Further, in a case in which a holding groove, into which the corresponding cable is inserted, is disposed adjacent to the first holding groove 24 or the second holding groove 25, the cable, which is about to come off, may also be supported by the cover side locking portions 35 which are hooked with the support side locking claws 26 positioned between the holding groove and the first holding groove 24 or between the holding groove and the second holding groove 25.
In the exemplary embodiment, at least two of the inside handle 6, the outside handle 7, and the release motor 8 may be connected to the mechanism part 2a of the remote control device 2 through cables. Further, in a case in which the holding grooves into which the plurality of cables is inserted are disposed in parallel in one direction, the plurality of cables, which is about to come off, may be supported by the cover side locking portions 35 which are hooked with the support side locking claws 26 positioned between the adjacent holding grooves.
In the exemplary embodiment, the direction in which the plurality of holding grooves is provided in parallel may be the front-and-rear direction or the height direction of the vehicle.
In the exemplary embodiment, the vehicle opening and closing body may be a swing door, a back door, a trunk lid, or the like.

Next, the technical spirit, which may be recognized from the above-described exemplary embodiments and separate examples, will be additionally described below.

A vehicle opening and closing body operating device according to an aspect of this disclosure includes: a support member having a vertical wall portion, a plurality of holding grooves into which cables are inserted and which are formed in the vertical wall portion to be opened in a standing direction of the vertical wall portion and to be in parallel in one direction, each of the holding grooves communicating in a plate thickness direction of the vertical wall portion, and a support side locking portion which is provided between the adjacent holding grooves; and a cover having a shaft portion supported on the vertical wall portion to be pivotable about an axis extending in the plate thickness direction, an arm portion extending from the shaft portion along the vertical wall portion to cover openings of the plurality of holding grooves, and a cover side locking portion provided on the arm portion and hooked with the support side locking portion.

According to this configuration, the cover supports the cables, which are about to come off from the respective first holding grooves, by the cover side locking portions that are hooked with the support side locking portions positioned between the adjacent first holding grooves. In this case, a separation distance between the cover side locking portion and each of the first holding grooves may be set to be smaller than a separation distance between the adjacent first holding grooves. Therefore, it is possible to reduce moment of force generated by the cables which are about to come off from the first holding grooves, and it is possible to further reduce the strength, which is required for the cover side locking portion and the like, to that extent.

In the vehicle opening and closing body operating device, the support side locking portion and the cover side locking portion may be provided to protrude on each side in the plate thickness direction.

According to this configuration, the two sets of support side locking portions and cover side locking portions, which are disposed at opposite sides in the front-and-rear direction, are hooked with each other, and as a result, the cover may more firmly support the cables which are about to come off from the respective first holding grooves.

In the vehicle opening and closing body operating device, the cover may have a release protrusion piece extending from the cover side locking portion in the standing direction.

According to the configuration, when the release protrusion pieces are elastically deformed in the plate thickness direction of the vertical wall portion toward the vertical wall portion, the cover side locking portions are elastically deformed by the reaction force in the front-and-rear direction away from the vertical wall portion, that is, in the direction in which a hooking area with the support side locking claws is decreased. Therefore, it is possible to more simply release the cover side locking portions from the support side locking claws, and further, it is possible to more smoothly perform an operation of removing the cover.

In the vehicle opening and closing body operating device, the arm portion may be provided with a pressing piece, which faces the openings of the plurality of holding grooves.

According to this configuration, it is possible to press and insert the cables, which are not completely assembled into the holding grooves, into the side (depth side) opposite to the openings by the pressing pieces, and as a result, it is possible to more reliably assemble the cables.

In the vehicle opening and closing body operating device, the temporary tacking hole and the temporary tacking protrusions, which minimally maintain a rotated position of the cover, may be provided on the vertical wall portion and the arm portion, respectively.

According to this configuration, as the temporary tacking hole and the temporary tacking protrusions are engaged with each other, a rotated position of the cover is minimally maintained, and as a result, it is possible to more improve assemblability of the cables.

In the vehicle opening and closing body operating device, one of a temporary tacking hole and a temporary tacking protruding portion may be provided on the vertical wall portion, the other of the temporary tacking hole and the temporary tacking protrusion may be provided on the arm portion, and the temporary tacking protrusion may be inserted into the temporary tacking hole such that the cover is maintained at a position where the openings of the holding grooves are opened.

The aspect of this disclosure has an effect capable of further reducing the strength required to prevent the plurality of cables from coming off.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle opening and closing body operating device comprising:
a support member having
a vertical wall portion,
a plurality of holding grooves into which cables are inserted and which are formed in the vertical wall portion to be opened in a standing direction of the vertical wall portion and to be in parallel in one direction, each of the holding grooves communicating in a plate thickness direction of the vertical wall portion, and
a support side locking portion which is provided between the adjacent holding grooves; and
a cover having
a shaft portion supported on the vertical wall portion to be pivotable about an axis extending in the plate thickness direction,
an arm portion extending from the shaft portion along the vertical wall portion to cover openings of the plurality of holding grooves, and
a cover side locking portion provided on the arm portion and hooked with the support side locking portion.

2. The vehicle opening and closing body operating device according to claim 1,
wherein the support side locking portion and the cover side locking portion are provided to protrude on each side in the plate thickness direction.

3. The vehicle opening and closing body operating device according to claim 1,
wherein the cover has a release protrusion piece extending from the cover side locking portion in the standing direction.

4. The vehicle opening and closing body operating device according to claim 1,
wherein the arm portion is provided with a pressing piece, which faces the openings of the plurality of holding grooves.

5. The vehicle opening and closing body operating device according to claim 1,
wherein one of a temporary tacking hole and a temporary tacking protruding portion is provided on the vertical wall portion,
the other of the temporary tacking hole and the temporary tacking protrusion is provided on the arm portion, and
the temporary tacking protrusion is inserted into the temporary tacking hole such that the cover is maintained at a position where the openings of the holding grooves are opened.
